(19) United States
(12) Patent Application Publication
(10) Pub. No.: US 2026/0233725 A1
(43) Pub. Date: Aug. 13, 2026

(54) VEHICLE BRAKE SYSTEM FOR FOUR WHEEL ELECTROMECHANICAL BRAKE (EMB) ARCHITECTURE

(71) Applicant: HL MANDO CORPORATION, Gyeonggi-do (KR)

(72) Inventors: Christian ROSS, Auburn, MI (US); Tomy SEBASTIAN, Auburn, MI (US); Raja RAMAKRISHNAN, Auburn, MI (US); Dheerajkumar PATEL, Auburn, MI (US); Lucas RITTER, Auburn, MI (US); Shakil HOSSAIN, Auburn, MI (US); Jonathan KNIEPER, Auburn, MI (US)

(21) Appl. No.: 19/458,053

(22) Filed: Jan. 23, 2026

Related U.S. Application Data
(60) Provisional application No. 63/758,304, filed on Feb. 13, 2025.

(51) Int. Cl. B60T 17/22; B60T 13/74

(52) U.S. Cl. CPC B60T 17/221; B60T 13/746; B60T 2270/402; B60T 2270/414

(57) ABSTRACT

A brake system for a vehicle is provided. The brake system includes: a first set of brakes installed on a first set of road wheels of the vehicle, the first set of road wheels includes two road wheels of the vehicle that are diagonal to one another; a second set of brakes installed on a second set of road wheels of the vehicle, the second set of road wheels includes another two road wheels of the vehicle that are diagonal to one another; and a brake controller assembly that controls the first set of brakes and the second set of brakes, the brake controller assembly includes a backup power source separate from a primary power source of the vehicle. The first set of brakes are connected to both the primary power source and the backup power source.

### CROSS REFERENCE TO RELATED PATENT APPLICATION(S)

This application claims the benefit of U.S. Patent Application Serial No. 63/758,304, filed on February 13, 2025, entitled “FOUR WHEEL ELECTROMECHANICAL BRAKE (EMB) VEHICLE ARCHITECTURE”, which is all hereby incorporated by reference in its entirety.

### BACKGROUND

Various embodiments of the present disclosure generally relate to a brake system for a vehicle and more particularly to a vehicle brake system for a four wheel electro-mechanical brake (EMB) architecture.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock, and electric or brake-by-wire brake systems. For example, in a hydraulic brake system, the hydraulic fluid transfers energy from a brake pedal to a brake pad for slowing down or stopping rotation of a wheel of the vehicle. Electronics control the hydraulic fluid in the hydraulic brake system. In an electric brake system, the application and release of the brake is controlled by an electric caliper or motor via an electrical signal.

These electric brake systems typically include an electro-mechanical actuator connected to a brake caliper either by a cable, as the drum in head, or directly attached to the brake caliper. The actuator converts electrical power to rotational mechanical output power for moving the cable or drive screw and applying the brakes. Generally, the electro-mechanical actuator includes an electric motor and a mechanical assembly for achieving the necessary load transfer.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a brake system for a vehicle may comprise: a first set of brakes installed on a first set of road wheels of the vehicle, the first set of road wheels comprising two road wheels of the vehicle that are diagonal to one another; a second set of brakes installed on a second set of road wheels of the vehicle, the second set of road wheels comprising another two road wheels of the vehicle that are diagonal to one another; and a brake controller assembly that controls the first set of brakes and the second set of brakes, the brake controller assembly comprising a backup power source separate from a primary power source of the vehicle, wherein the first set of brakes are connected to both the primary power source and the backup power source, and the second set of brakes are connected to only the primary power source.

Each brake making up the first set of brakes and the second set of brakes is an electromechanical brake (EMB).

The first set of road wheels comprise a front left road wheel and rear right road wheel of the vehicle, and the second set of road wheels comprise a front right road wheel and a rear left road wheel of the vehicle.

The brake controller assembly further comprises a redundant controller architecture comprising a first electronic control unit (ECU) and a second ECU, and only the first ECU among the first and second ECUs is connected to the backup power source.

The brake controller assembly further comprises a switching circuit that is configured to switch the first ECU from the primary power source to the backup power source when the switching circuit detects that the primary power source has failed.

The switching circuit is a fully analog circuit implemented using one or more power transistors.

The one or more power transistors comprise a Metal-Oxide-Semiconductor Field-Effect Transistor (MOSFET).

The switching circuit is further configured to switch the first set of brakes to the backup power source when the switching circuit detects that the primary power source has failed.

The backup power source comprises a super capacitor.

The backup power source comprises a lithium rechargeable battery.

The first ECU and the first set of brakes are configured such that upon failure of the primary power source, only the first ECU and the first set of brakes are operational while the second ECU and the second set of brakes are non-operational.

The second set of brakes are configured to be unable to provide braking for the vehicle when non-operational.

Each brake making up the first set of brakes and the second set of brakes are configured to become non-operational and be unable to provide braking for the vehicle when electrical power to any of each brake making up the first set of brakes and the second set of brakes is lost.

The backup power source comprises an amount of electrical power that is enough for providing one full stop for a braking of the vehicle using the first set of brakes, the one full stop including setting of at least one parking brake of the first set of brakes.

The brake controller assembly further comprises a health monitor unit configured to monitor a health status of the backup power source.

The brake system is compliant with ECE R13H braking specifications.

The first set of brakes are connected to the brake controller assembly via a first data communication line and the second set of brakes are connected to the brake controller assembly via a second data communication line separate from the first data communication line.

The first data communication line is a first private controller area network (CAN) bus and the second data communication line is a second private CAN bus.

The brake controller assembly is separate from a chassis controller of the vehicle.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1A is a diagram illustrating a brake system of a vehicle according to an exemplary embodiment of the present disclosure.

FIG. 1B is a diagram illustrating an example brake controller assembly configuration of the brake system of FIG. 1A according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

FIG. 2 is an implementation example of the brake system of FIG. 1A according to an exemplary embodiment of the present disclosure.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

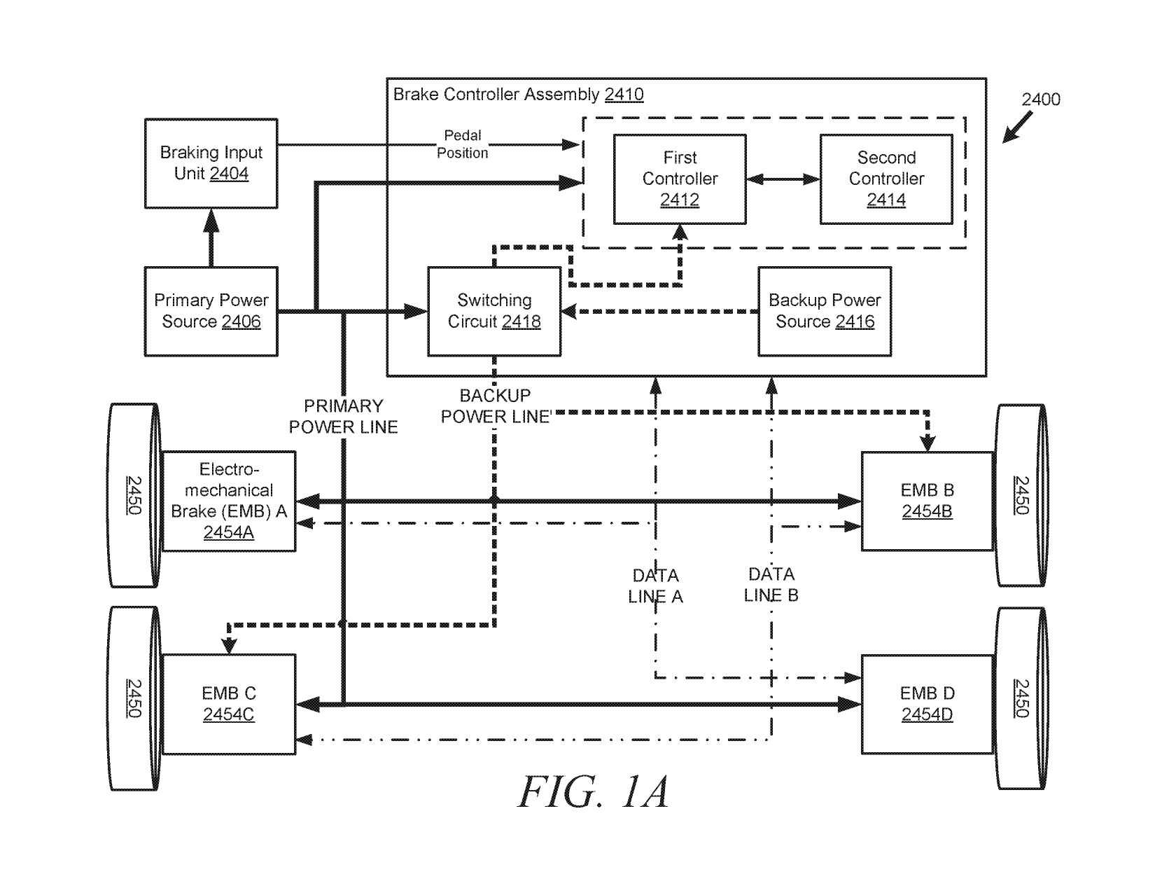

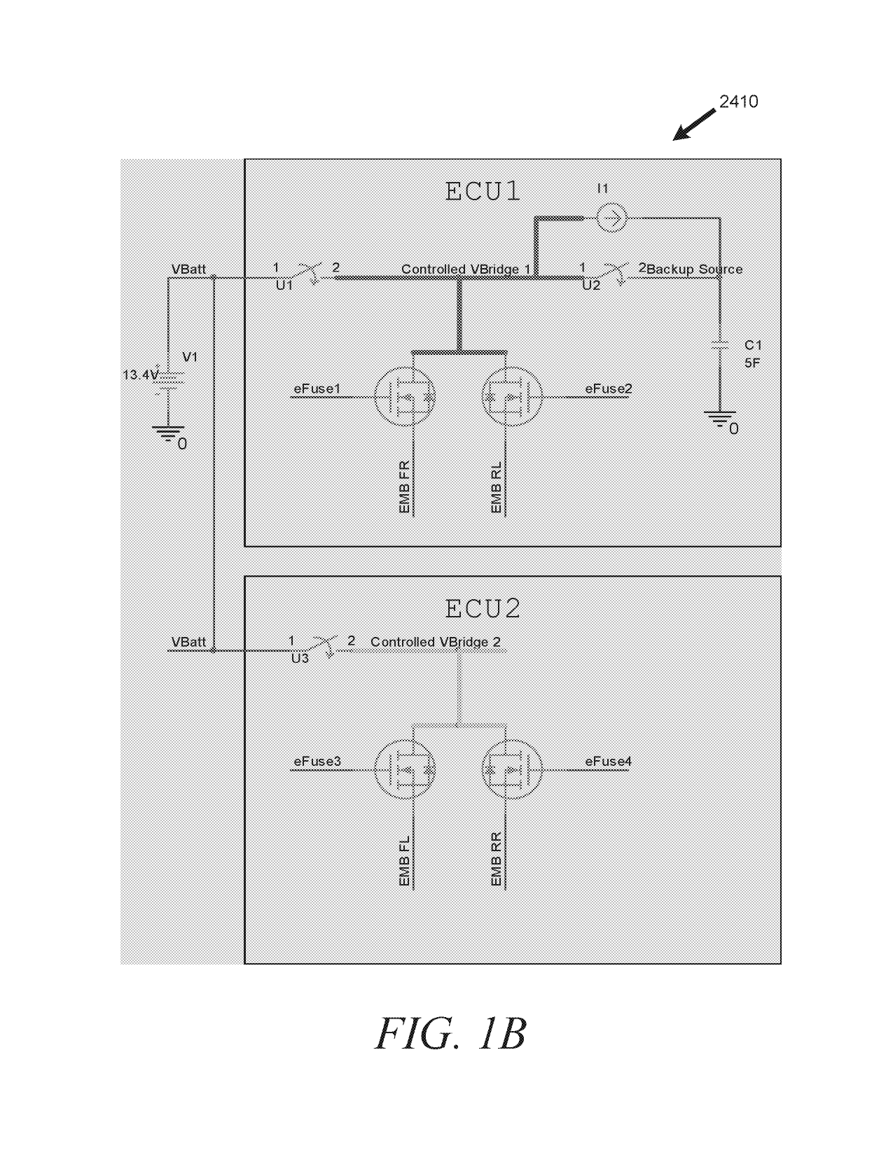

Turning now to FIG. 1A, FIG. 1A shows a brake system 2400 of a vehicle (i.e., a motor vehicle) according to an exemplary embodiment of the present disclosure. In embodiments, the brake system 2400 of FIG. 1A is compatible with any type of steering systems (e.g., steer-by-wire, power steering, rack and pinion steering, recirculating ball steering, hydraulic power steering, electric power steering, manual steering, or the like). In embodiments, the brake system 2400 of FIG. 1A may be configured as a brake-by-wire brake system.

As shown in FIG. 1A, the vehicle includes four road wheels 2450 (also referred to herein simply as “wheel 2450”). Each of the road wheels is installed with an electromechanical brake (EMB) (i.e., EMBs 2454A-2454D). Each EMB 2454A-2454D may include a parking brake. Alternatively, only the EMBs 2454C and 2454D installed on the rear wheels are provided with parking brakes.

Each EMB may be any type of electro-mechanical brake that utilizes a “brake-by-wire” braking/brake system that uses electric motors at each wheel 2450 to apply braking force, completely replacing hydraulic fluid and mechanical linkages. This advantageously allows for faster response times, independent and precise control of each wheel for improved safety and stability, and a simpler, cleaner design with fewer components. EMBs are considered the future of braking, especially for electric and autonomous vehicles, as they enable more advanced chassis control, regenerative braking, and reduced maintenance.

However, due to the lack of hydraulic fluid and mechanical linkages, EMBs may become completely non-operational (i.e., unable to function and provide any braking capabilities for the vehicle) when power (i.e., electrical power) to the EMBs is lost. For example, should a power source powering the EMBs 2454A-2454D fail, the vehicle will also lose the capability to brake. Thus, a new brake system that can support such full (i.e., four wheel) EMB architecture is needed. Such new brake system not only needs to conform to various braking safety standards (e.g., the ECE R13H braking specifications, or the like) but also needs to prevent adding additional weight and costs (e.g., through addition of a secondary vehicle battery, or the like) to the vehicle as well.

Embodiments disclosed herein (namely, the brake system 2400) are designed to address and resolve the above-discussed problems of such full (i.e., four wheel) EMB architecture, and will be described in more detail as follows.

Turning back to FIG. 1A, the brake system 2400 of embodiments disclosed herein includes a brake controller assembly 2410 made up of a first controller 2412, a second controller 2414, a switching circuit 2418, and a backup power source 2416. Each of the first and second controllers 2412 and 2414 can be configured as, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components.

In one example of embodiments disclosed herein, the first controller 2412 may be configured to act as a primary ECU that controls all of the EMBs 2454A-2454D while the second controller may be configured as a backup (e.g., redundant) ECU that kicks in should the primary ECU fail. Alternatively, in another example of embodiments disclosed herein (discussed in more detail below in reference to FIG. 1B) both of the first controller 2412 and the second controller 2414 may act as primary ECUs and separately control two EMBs 2454A-2454D each.

The switching circuit 2418 may be configured to detect failure within a primary power source 2406 (e.g., a main vehicle battery) of the vehicle in order to switch a connection between certain components (e.g., some of the EMBs 2454A-2454D, the first controller 2412, or the like) of the brake system 2400 between the primary power source 2406 to the backup power source 2416. Said another way, when the primary power source 2406 is working, the switching circuit 2418 connects the components of the brake system 2400 with the primary power source 2406. And when the primary power source 2406 fails, the switching circuit 2418 connects the components of the brake system 2400 with the backup power source 2416.

In embodiments, the switching circuit 2418 may be implemented using purely analog components. For example, the switching circuit 2418 may be configured using a combination of physical switches and transistors (e.g., power Metal-Oxide-Semiconductor Field-Effect Transistors (MOSFETs), bipolar junction transistors (BJTs), or the like). Having the switching circuit 2418 be configured in a purely analog manner advantageously increases a detection and response time of the power failure (of the primary power source 2406) as compared to using a digital and analog hybrid (e.g., using microcontrollers to detect and process power levels, current, or the like) configuration.

In embodiments, the switching circuit 2418 may also be referred to as a “Power OR” circuit (as will be described in more detail below in reference to FIG. 1B). In one example of embodiments disclosed herein, the switching circuit 2418 may be implemented as part of the first controller 2412 (e.g., installed on a printed circuit board (PCB), or the like, of the first controller 2412). In another example, the switching circuit 2418 may be implemented as its own individual component (or combination of components on its own PCB or the like) separate from the other components (i.e., the first controller 2412, the second controller 2414, the backup power source 2416) of the brake controller assembly 2410.

The backup power source 2416 may be implemented as a super capacitor or as a lithium rechargeable battery. Each of these example components may be charged up (or hold a charge) that is predetermined by a manufacturer of the brake system 2400 (and/or the vehicle) as being necessary for being able to provide one complete full stop (i.e., one complete full brake) of the vehicle while also having enough charge (e.g., electrical power) to set at least one of the parking brakes (also referred to herein as “park brakes”) of the EMBs 2454A-2454D (namely, one of the parking brakes of an EMB installed on a rear wheel of the vehicle).

In one example, assume that a power of at least 200 Joules (J) is required for a 0.4G deceleration for 5 seconds from 70 kilometers per hour to a fully stopped position. Using such conditions while also assuming a capacitor charging capability of 16 volts with a current limited charging circuit, the minimum required capacitance would be 2 farads (F) with a final voltage at 7 volts on the bulk capacitance. Additionally, about 1.8F would be required for each additional stopping event. Other constraints that are considered here include: a 40 amperage (40A) peak; enough energy to perform at least one secondary brake apply and EMB parking brake apply maneuver; and a 10+ year lifetime for the backup power source 2416. As a result of such constraints and conditions, if a super capacitor is used as the backup power source 2416, the super capacitor may have the following properties: 6s2p provides 5F @ 18V rating; 2F required with a starting voltage of 16V on capacitors; 12mm d * 25mm h * 12 pieces; or the like. If a lithium rechargeable battery is used, the lithium rechargeable battery may have the properties of: 5mAh battery; or the like. Both the super capacitor and the lithium rechargeable battery may be kept charged using a charging circuit (not shown) that receives power from the primary power source 2406.

In embodiments, although not shown in FIG. 1A, the brake controller assembly 2410 may include an energy storage health monitor unit and/or circuit (e.g., as part of first controller 2412, separate from first controller 2412, or the like) that monitors a health and voltage charge of the backup power source 2416 (e.g., the super capacitor and the lithium rechargeable battery). This advantageously ensures that the brake controller assembly 2410 (and a vehicle chassis controller or the like that communicates with the brake controller assembly) is always aware of the health and capabilities of the backup power source 2416. For example, should the energy storage health monitor unit and/or circuit detect that the backup power source 2416 is no longer holding a charge (or not holding enough of a charge), the brake controller assembly 2410 (and/or the chassis controller of the vehicle) may issue a warning (e.g., to the driver, the manufacturer, or the like) to have the backup power source 2416 checked on and/or replaced.

In embodiments, the brake system 2400 may also include a braking input unit 2404 and the primary power source 2406. As discussed, the primary power source 2406 may be the main battery of the vehicle. The braking input unit 2404 may include at least one or more sensors (e.g., a pedal sensor, or the like) that is able to provide vehicle braking operation information (e.g., pedal position, vehicle speed, or the like) to the first and second controllers 2412 and 2414 of the brake controller assembly 2410. The first and second controllers 2412 and 2414 may then use (e.g., process) such vehicle braking operation information in order to operate the EMBs 2454A-2454D.

As additionally shown in FIG. 1A, all of the EMBs 2454A-2454D may be connected to (e.g., via primary power lines) and receive power from the primary power source 2406. The primary power source 2406 may also provide power to at least the braking input unit 2404, the first controller 2412, the second controller 2414, and the backup power source 2416), and may be connected to the switching circuit 2418. Said another way, when the primary power source 2406 is operational (i.e., has not failed), all of these components are powered by the primary power source 2406.

As further shown in FIG. 1A, the switching circuit 2418 connects the first controller 2412 and at least two of the EMBs 2454A-2454D to the backup power source 2416. The second controller 2414 is not connected to the backup power source 2416. Said another way, should the primary power source 2406 fail, the first controller 2412 and at least two of the EMBs 2454A- 2454D will be switched (by the switching circuit 2418 upon detection of such failure) to receive power instead from the backup power source 2416. Additionally, although not explicitly shown in FIG. 1A (for the sake of brevity), the switching circuit 2418 also connects the backup power source 2416 to the braking input unit 2404.

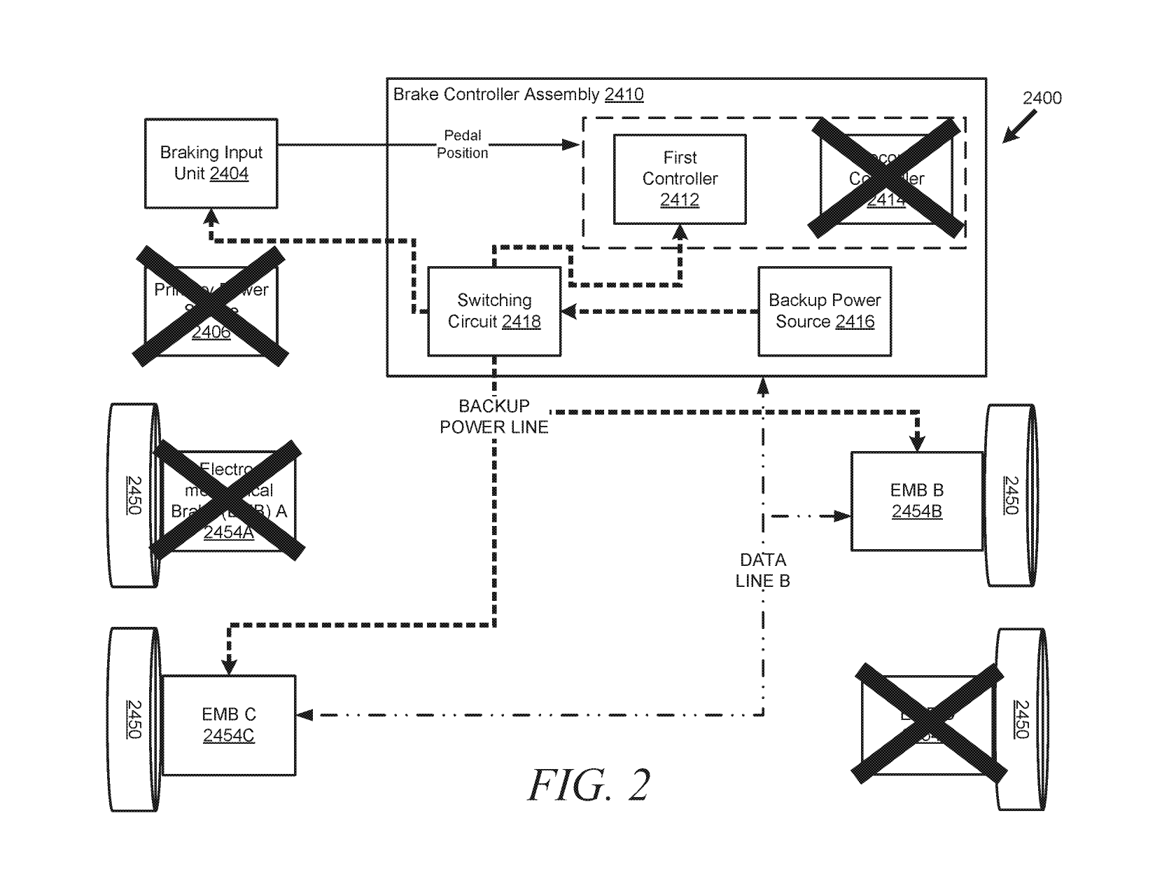

In embodiments and as shown in FIG. 1A, the two of the EMBs 2454A-2454D that are connected to the backup power source 2416 may be diagonal to one another. Said another way, at least one front EMB (e.g., 2454B as shown in FIG. 1B) and its diagonal rear counterpart (e.g., 2454C as shown in FIG. 1A) will be connected to the backup power source 2416 (e.g., via the backup power lines). This advantageously ensures, when the primary power source 2406 has failed, a secondary brake apply and EMB parking brake apply maneuver that still meets (i.e., conforms) to international braking safety standards (e.g., the ECE R13H braking specifications, or the like). This will be discussed in more detail below in refernce to the implementation example shown in reference to FIG. 2.

As additionally shown in FIG. 1A, the EMBs 2454A-2454D may be grouped together as diagonal pairs. In particular, EMB A 2454A and EMB D 2454D may be grouped together as one set of brakes while EMB B 2454B and EMB C 2454C may be grouped together as another set of brakes. The EMB A 2454A and EMB D 2454D pair may communicate with each other and the brake controller assembly 2410 using a first data line (i.e., data line A shown in FIG. 1A). The EMB B 2454B and EMB C 2454C pair may communicate with each other and the brake controller assembly 2410 using a second data line (i.e., data line B shown in FIG. 1A). Each of the data lines may be implemented using a communication bus and/or communication channel (e.g., a private controller area network (CAN) bus/channel, Ethernet, or the like). Separate data lines may connect these sets of brakes with other controllers (e.g., a main chassis controller of the vehicle, or the like) installed within the vehicle.

Turning now to FIG. 1B, FIG. 1B shows is a diagram illustrating an example brake controller assembly configuration of the brake system of FIG. 1A according to an exemplary embodiment of the present disclosure. The example shown in FIG. 1B should not be used to limit embodiments disclosed herein to any one particular configuration and is only presented as one non-limiting example configuration in which the brake controller assembly 2410 can be implemented.

As shown in the example of FIG. 1B, each controller (i.e., the first controller 2412 as ECU 1 and the second controller 2414 as ECU 2) may be connected to and controls diagonal pairs of the EMBs 2454A-2454D. Specifically, ECU 1 is connected to and controls the front right (FR) and rear left (RL) EMBs while ECU 2 is connected to and controls the front left (FL) and rear right (RR) EMBs. Each controller may also include any number of electrical fuses (eFuses) that protect the EMBs from current surges or the like.

As further shown in the example of FIG. 1B, the switching circuit 2418 (implemented as controlled VBridge 1 and Controlled VBridge 2 in FIG. 1B) may prevent complete loss of braking by allowing at least ECU 1 to be reconnected to (i.e., switched to) the backup source (i.e., backup power source 2416) from VBatt (i.e., the primary power source 2406). In particular, the switching circuit 2418 may be implemented using a combination of power MOSFETs that are used to OR the two sources (i.e., VBatt and Backup Srouce) together. Upon loss of VBatt, switch U1 will open while switch U2 will close, connecting the Backup Source to the two EMBs connected to and controlled by ECU 1. In this example, switch U2 will remain closed during standard operation (i.e., when VBatt has not failed) and only be turned on when VBatt has failed. Drivers for the switches (e.g., U1, U2, U3) may also contain reverse battery and/or over-temperature protection mechanisms.

Turning now to FIG. 2, FIG. 2 is an implementation example of the brake system of FIG. 1A according to an exemplary embodiment of the present disclosure. More specifically, FIG. 2 shows a state where the primary power source 2406 has failed, as marked by a X over the diagram for primary power source 2406.

In such a state where the primary power source 2406 has failed, the second controller 2414 and two EMBs (e.g., here EMB A 2454A and EMB D 2454D) loses power completely and becomes fully non-operational (i.e., fully incapable of providing any functions and/or capabilities these components were designed to provide).

As further shown in FIG. 2, the switching circuit 2418 has detected the failure of the primary power source 2406 and has switched some of the components of brake system 2400 to instead receive power from the backup power source 2416. In particular, the braking input unit 2404 (namely, that provides pedal sensing to the brake controller assembly 2410), the first controller 2412 (namely, that receives the pedal sensing), EMB B 2454B, and EMB C 2454C are now powered by the backup power source 2416.

As a result of such switching to the backup power source 2416, these remaining powered up components (i.e., braking input unit 2404, first controller 2412, EMB B 2454B, and EMB C 2454C) are able to work together (i.e., in tandem) to provide at least one secondary brake apply and EMB parking brake apply maneuver to attempt to bring the vehicle to a full (i.e., complete stop) using the charge (i.e., electrical charge) stored in the backup power source 2416.

Such a configuration shown in the implementation example of FIG. 2 not only advantageously conforms the brake system 2400 to international braking safety standards (e.g., the ECE R13H braking specifications, or the like) but also effectively reduces the cost and complexity of the brake system 2400 by not requiring another vehicle battery to be installed as a backup battery for the primary power source 2406. Thus, the above-discussed problems associated with using a full (i.e., all four-wheel) EMB architecture are resolved, and a new and improved brake system is obtained.

Although the example embodiments have been described in detail, it should be understood that various changes, substitutions and alterations can be made herein without departing from the spirit and scope of the application as defined by the appended claims.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A brake system for a vehicle, the brake system comprising:
a first set of brakes installed on a first set of road wheels of the vehicle, the first set of road wheels comprising two road wheels of the vehicle that are diagonal to one another;
a second set of brakes installed on a second set of road wheels of the vehicle, the second set of road wheels comprising another two road wheels of the vehicle that are diagonal to one another; and
a brake controller assembly that controls the first set of brakes and the second set of brakes, the brake controller assembly comprising a backup power source separate from a primary power source of the vehicle,
wherein the first set of brakes are connected to both the primary power source and the backup power source, and the second set of brakes are connected to only the primary power source.

2. The brake system of claim 1, wherein each brake making up the first set of brakes and the second set of brakes is an electromechanical brake (EMB).

3. The brake system of claim 2, wherein the first set of road wheels comprise a front left road wheel and rear right road wheel of the vehicle, and the second set of road wheels comprise a front right road wheel and a rear left road wheel of the vehicle.

4. The brake system of claim 2, wherein the brake controller assembly further comprises a redundant controller architecture comprising a first electronic control unit (ECU) and a second ECU, and only the first ECU among the first and second ECUs is connected to the backup power source.

5. The brake system of claim 4, wherein the brake controller assembly further comprises a switching circuit that is configured to switch the first ECU from the primary power source to the backup power source when the switching circuit detects that the primary power source has failed.

6. The brake system of claim 5, wherein the switching circuit is a fully analog circuit implemented using one or more power transistors.

7. The brake system of claim 6, wherein the one or more power transistors comprise a Metal-Oxide-Semiconductor Field-Effect Transistor (MOSFET).

8. The brake system of claim 5, wherein the switching circuit is further configured to switch the first set of brakes to the backup power source when the switching circuit detects that the primary power source has failed.

9. The brake system of claim 8, wherein the backup power source comprises a super capacitor.

10. The brake system of claim 8, wherein the backup power source comprises a lithium rechargeable battery.

11. The brake system of claim 8, wherein the first ECU and the first set of brakes are configured such that upon failure of the primary power source, only the first ECU and the first set of brakes are operational while the second ECU and the second set of brakes are non-operational.

12. The brake system of claim 11, wherein the second set of brakes are configured to be unable to provide braking for the vehicle when non-operational.

13. The brake system of claim 8, wherein each brake making up the first set of brakes and the second set of brakes are configured to become non-operational and be unable to provide braking for the vehicle when electrical power to any of each brake making up the first set of brakes and the second set of brakes is lost.

14. The brake system of claim 8, wherein the backup power source comprises an amount of electrical power that is enough for providing one full stop for a braking of the vehicle using the first set of brakes, the one full stop including setting of at least one parking brake of the first set of brakes.

15. The brake system of claim 8, wherein the brake controller assembly further comprises a health monitor unit configured to monitor a health status of the backup power source.

16. The brake system of claim 2, wherein the brake system is compliant with ECE R13H braking specifications.

17. The brake system of claim 2, wherein the first set of brakes are connected to the brake controller assembly via a first data communication line and the second set of brakes are connected to the brake controller assembly via a second data communication line separate from the first data communication line.

18. The brake system of claim 17, wherein the first data communication line is a first private controller area network (CAN) bus and the second data communication line is a second private CAN bus.

19. The brake system of claim 17, wherein the brake controller assembly is separate from a chassis controller of the vehicle.
